(19) United States
(12) Patent Application Publication
(10) Pub. No.: US 2024/0318579 A1
(43) Pub. Date: Sep. 26, 2024

(54) HOUSING STRUCTURE FOR A TURBOMACHINE

(71) Applicant: MTU Aero Engines AG, München (DE)

(72) Inventor: Manfred Feldmann, Eichenau (DE)

(73) Assignee: MTU Aero Engines AG, München (DE)

(21) Appl. No.: 18/601,831

(22) Filed: Mar. 11, 2024

(30) Foreign Application Priority Data
Mar. 21, 2023 (DE) 10 2023 106 999.3

(51) Int. Cl. F01D 25/24

(52) U.S. Cl. CPC F01D 25/24; F05D 2220/30; F05D 2240/14

(57) ABSTRACT

The invention relates to a housing structure for a turbomachine, with a housing shell and at least one containment ring arranged in therein, wherein the housing structure surrounds a flow channel in a ring-shaped manner, in which at least one rotating stage with a guide vane arrangement and a rotating blade arrangement is arranged, as well as a turbomachine having such a housing structure.

### BACKGROUND OF THE INVENTION

The invention relates to a housing structure for a turbomachine with a housing shell and at least one containment ring arranged therein, wherein the housing structure surrounds a flow channel in a ring-shaped manner, in which at least one rotating stage with a guide vane arrangement and a rotating blade arrangement is arranged.

In the case of failure of a rotating rotor element, housing structures of turbomachines are set up to prevent a penetration of the housing due to high active centrifugal forces so as to avert any danger to persons and goods in the surroundings of the turbomachine.

Accordingly, one function of a housing structure of a turbomachine is to prevent any radial escape of fragments, in particular fragments of rotating blades, in the radial direction out of the turbomachine. This function is referred to as “containment.” Especially for turbomachines with fast-rotating turbines, this requirement leads to very large wall thicknesses and a correspondingly detrimentally heavy weight of the housing structure. In addition, thick housing walls hinder the dissipation of heat, so that the containment capability of the walls is further degraded on account of high material temperatures. It is known to design housing structures of turbomachines in multishell constructions. In this way, it is possible to reduce the total wall thickness and accordingly the weight and the heat capacity of the housing structure of the turbomachine.

### SUMMARY OF THE INVENTION

Based on this, an object of the present invention is to make available a housing structure with an improved containment capability.

Proposed for achieving this object is a housing structure for a turbomachine with a housing shell and at least one containment ring arranged in it, wherein the housing structure surrounds a flow channel in a ring-shaped manner, in which at least one rotating stage with a guide vane arrangement and a rotating blade arrangement is arranged. In this case, at least one containment ring extends essentially over the axial length of (only) one rotating stage and is arranged spaced radially apart from the housing shell at least in sections, whereby, owing to the radial spacing, at least one cavity is formed between the at least one containment ring and the housing shell.

The housing shell of the housing structure is formed to absorb the loads acting on the housing structure internally and externally during operation of the turbomachine. The housing shell in this case indeed has a containment function, but, in particular, as such, does not have an adequate containment capability.

Arranged in the housing shell is at least one containment ring, which surrounds a flow channel of the turbomachine in a ring-shaped manner. At least one rotating stage, which has a guide vane arrangement and a rotating blade arrangement, is arranged inside of the flow channel of the turbomachine. In particular, the guide vane of the rotating stage is connected to the housing shell. The at least one containment ring is arranged, in particular, concentrically with respect to the axis of rotation or turbomachine axis of the turbomachine. At least one containment ring is designed here as a closed ring, that is, as an unsegmented ring. In the case of a closed ring—in contrast to a ring composed of individual segments—it is possible to afford uniformly the containment capability along the circumference in a positionally independent manner. This is important for the construction design. As a closed ring, a containment ring can absorb, in particular, high circumferential forces, which, for example, result from forces acting radially on it. For example, the at least one containment ring is designed as a solid rotating part without, in particular, integrally bonded joints, as a turned wrought ring or turned cast part by way of example. Depending on the required ability to withstand loads, a containment ring can also be produced from a closed sheet metal ring with welded joints

In the proposed housing structure, at least one containment ring that is arranged in the housing shell extends essentially over the axial length of (only) one rotating stage, which comprises a guide vane arrangement and a rotating blade arrangement. As the term only in parentheses indicates, the formulation “one containment ring arranged in the housing shell extends essentially over the axial length of one rotating stage” is to be understood as meaning that the containment ring does not extend, in particular, over more than the axial length of a single rotating stage. The containment ring thus surrounds the region of a rotating stage in which, in the event of failure of a rotating blade or rotating blade arrangement (which, for example, can be designed as a rotor disk with blades mounted on it or as a one-part, integrated rotor disk or blisk), the fragments thereof are accelerated radially outward, for which reason a containment capability of the surrounding housing structure is required. Owing to the limitation of the axial length of the containment ring to about the axial length of a rotating stage, the containment capability can be fulfilled only locally by the at least one additional containment ring, so that the housing shell does not need to assume this function entirely. Accordingly, the containment capability of the housing structure is increased for a relatively low additional weight, which is also associated with advantages for the turbomachine in terms of weight.

In the proposed housing structure, at least one containment ring is arranged spaced radially apart, at least in sections, from the housing shell. A radial spacing of the containment ring from the housing shell, at least in sections, makes possible an appreciable thermal decoupling of the containment ring from the housing shell. In particular, by way of an abutting contact between a containment ring and the housing shell, a thermal coupling is also smaller than for a one-part thicker design of the wall of the housing shell.

The radial spacing between the at least one containment ring and the housing shell results in the formation of at least one cavity. The at least one cavity, in conjunction with an insulation effect, in particular of air present in it, makes possible an effective cooling function of the housing structure. Furthermore, the spacing of the at least one containment ring from the housing shell results in a larger radial extension of the containment region, so that, in the region of a cavity, there does not exist, in particular, any direct mechanical interaction between the at least one containment ring and the housing shell.

The proposed housing structure has containment regions in a multishell construction, as a result of which the load on the individual shells or containment rings can be kept in the more favorable damage mechanism of denting and subsequent rupturing under predominant tensile load. Cracks in a radial containment ring are stopped at the respective containment ring, so that an overstress due to a crack cannot lead to a rapid failure of the housing structure. Accordingly, the summed wall thickness and thus the weight of the housing structure and thus also of the turbomachine can be reduced. In particular, when a plurality of containment rings are used, each of these rings can be designed as a separate, isolated component, which, in itself, can be inspected separately and, as such, can be replaced. Accordingly, each containment ring can be manufactured individually, also from various materials, for example.

Beyond this, owing to the multishell construction of the housing structure in the containment regions, it is possible to use the containment rings arranged in one another to carry cooling air in order to keep the material temperature low and thereby the containment capability high.

In an embodiment, the housing structure has at least two containment rings that extend over the same rotating stage. In this case, the at least two containment rings are arranged, in particular, concentrically with respect to one another and radially in one another. Accordingly, the load on the individual containment rings can be kept in the already mentioned favorable damage mechanism of denting and subsequent rupture under predominant tensile load. It is also possible here to keep the wall thickness of each individual containment ring advantageously smaller than is the case when only one containment ring is used. Furthermore, a multipart construction of the housing structure also makes possible expanded possibilities for design of the housing structure and of the at least two containment rings. Thus, they can be designed to adapt better to the respective requirements of the housing structure, in particular in terms of containment capability and heat dissipation.

In an embodiment of the housing structure, the at least two containment rings are arranged spaced radially apart from one another at least in sections. Analogously to the spacing of a containment ring of the housing shell, this results in a thermal decoupling of the at least two containment rings from one another, whereby a thermal coupling by way of an abutting contact between two containment rings is smaller than for a one-part thicker design of a containment ring.

In an embodiment of the housing structure, the radial spacing between the at least one containment ring and the at least one second containment ring results in the formation of at least one cavity. The at least one cavity, in conjunction with an insulating effect of air present in it, makes possible, in particular, a further effective cooling function of the housing structure. Furthermore, the spacing of the at least two containment rings results in a larger radial extension of the containment region, so that, in the region of a cavity, in particular, there does not exist any direct mechanical interaction between the at least two containment rings.

In an embodiment of the housing structure, the at least one cavity is formed for carrying a flow of cooling air. In particular, the at least one containment ring and/or the housing shell are or is hereby designed in such a way that the at least one cavity or the walls thereof makes or make it possible to carry suitably a flow of cooling air streaming through the cavity, as a result of which a further improved cooling function of the housing structure can be achieved. In particular, the cavity has air inlet openings and air outlet openings arranged at suitable positions, as a result of which the cavity forms a flow channel through which a flow of air can stream and thus makes possible an improved cooling function of the housing structure. In particular, by way of a suitable design of at least one of the walls of, in particular, the at least one containment ring or the housing shell forming the cavity, the at least one cavity can be designed to divert a flow of cooling air in the cavity, in particular in the manner of a kind of labyrinth seal, as a result of which a further improved cooling effect can be achieved.

In an embodiment of the housing structure, the at least one cavity is formed so that cooling air can flow through it from an upstream lying cooling air source and, in another embodiment of the housing structure, the at least one cavity is formed so that cooling air can flow through it from a downstream lying cooling air source. Depending on the circumstances inside of the housing structure, the cavity and, in particular, the air inlet openings and air outlet openings thereof are formed and arranged so that a suitable flow of cooling air through the at least one cavity can be created in order to dissipate heat from the housing structure and thereby to improve further the containment function of the housing structure.

In an embodiment of the housing structure, at least one containment ring is arranged spaced apart, at least in sections, from the seal support radially surrounding the rotating stage. In particular, the at least one containment ring and the seal support hereby have essentially the same axial extension, as a result of which there are associated advantages in terms of the weight of the housing structure and thus of the turbomachine. Accordingly, the at least one containment ring after the seal support represents a first barrier for an element that is accelerated radially outward as a result of damage. In this embodiment, it can be advantageous for the at least one containment ring and the seal support to have, on at least one side, in particular an axial side, a common and/or interacting fastening, in particular at the housing shell or at a further element of the turbomachine and/or housing structure. In this way, a simple or efficient fastening of the at least one containment ring, in particular also in conjunction with the seal support, at the housing structure is made possible.

In an embodiment of the housing structure, a cavity that is formed between the containment ring and the seal support provides scaling against an axial flow and/or an insulating clement is arranged in it. A sealing of the seal support with respect to the radially surrounding region of the turbomachine against a throughflow of air, in particular also by use of an insulating clement, makes possible a reduction in the leakage flow in the region around the flow channel and thus also an improved efficiency of the turbomachine. Besides the sealing effect, an insulating element, in particular an insulating element surrounding the seal support, makes possible a further reduction in the heating of, in particular, the housing structure.

In an embodiment of the housing structure, a containment ring and the housing shell form at least one mount for a section of at least one adjoining guide vane. Such a mount can serve, in particular, for radial securing of the guide vane in the turbomachine. In such an embodiment, the containment ring can assume, beyond the containment function, also a structural function of the turbomachine.

In an embodiment of the housing structure, an axial front end and/or back end of at least one containment ring are or is arranged in a fastening region of the seal support and/or of the guide vane at the housing shell. This embodiment makes possible, in particular, besides a corresponding length of the containment ring and the seal support, a common fastening of the containment ring and the seal support on at least one axial side. In this way, in particular, it is possible for structural functions, for example, to be distributed onto a plurality of components and/or for structural functions to be used by a plurality of components, such as, for example, housing hooks and/or structural elements in the region of module interfaces. Correspondingly, advantages also ensue in an embodiment in which an axial front end and/or back end of at least one seal support are or is arranged in a fastening region of at least one containment ring and/or of the guide vane at the housing shell.

Preferably, the housing shell (35) (alone) does not have a required containment capability, but rather the required containment capability is afforded only together with the containment ring or containment rings. This makes possible a construction that is especially efficient in terms of weight and function.

In an embodiment of the housing structure, the axial extension of at least one of the containment rings lies in a region that extends from at least the axial extension of a rotating blade arranged inside of the containment ring up to twice the axial extension of such a rotating blade. The axial extension of a rotating blade hereby corresponds to the maximum axial distance between the leading edge (LE) of the blade and the trailing edge (TE) of the blade in the installed state. This maximum distance usually lies in a radial inner region of the blade.

In an embodiment of the housing structure, the at least one containment ring is fabricated from a material that differs from the material of the housing shell. The use of a material that, in particular, has properties suitable to meet the requirements of a containment ring, in particular in regard to strength and/or thermal conductivity, can further improve the containment function of the housing structure. Accordingly, in an embodiment, it is also possible to fabricate at least one containment ring from a material that differs from the material of at least one other containment ring in order to fulfill various requirements, in particular in regard to strength and/or thermal conductivity for further improvement of the containment function of the housing structure.

In an embodiment, the housing structure forms an outer housing of a turbomachine. On account of, in particular, a slender blade shape and the high speeds of rotation of turbine blades, increased requirements are placed on the containment capability at the housing structure of a turbomachine in the region of the turbine. The proposed housing structure is suited to fulfill such high requirements.

Proposed in an aspect is also a turbomachine with a housing structure that has at least one feature of the preceding described embodiments.

Further features, advantages, and possible applications of the invention ensue from the following description in conjunction with the figures. In general, it holds that features of the various aspects and/or embodiments described herein by way of example can be combined with one another insofar as this is not explicitly excluded in connection with the disclosure.

### BRIEF DESCRIPTION OF THE DRAWING FIGURES

In the following part of the description, reference is made to the figures, which are shown for highlighting specific aspects and embodiments of the present invention. It is obvious that other aspects can be used and that structural or logical changes in the illustrated embodiments are possible without leaving the scope of the present invention. The following description of the figures is therefore to be understood as non-limitative. Shown are:

FIG. 1 is a schematic illustration of an exemplary embodiment of a turbomachine;

FIG. 2 is a schematic sectional illustration of an exemplary embodiment of a section of a housing structure according to the invention; and

FIG. 3 is a further schematic sectional illustration of an exemplary embodiment of a section of a housing structure according to the invention.

### DESCRIPTION OF THE INVENTION

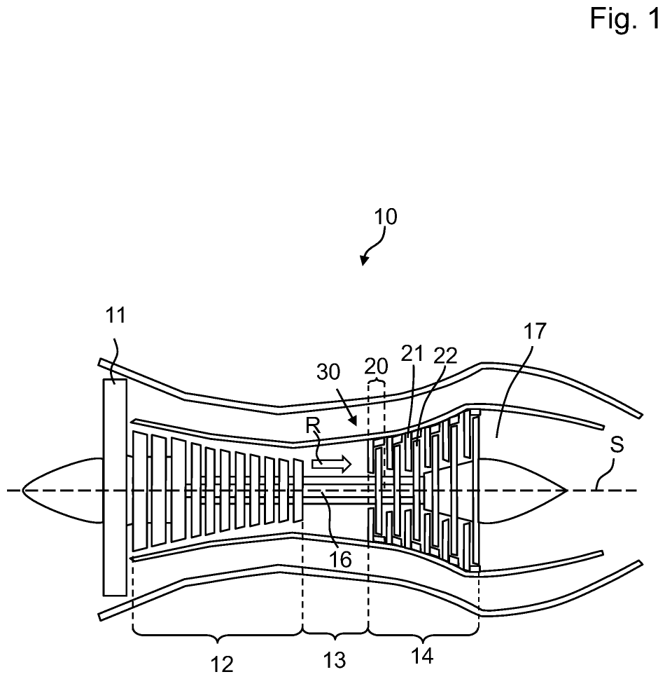

FIG. 1 shows a schematic illustration of an exemplary embodiment of a turbomachine 10 in a side view along the turbomachine axis S.

The turbomachine 10 has a housing structure 30 and, arranged one after the other in the flow direction R, a fan 11, a compressor 12, a combustion chamber 13, and a turbine 14, through which a gas flow can stream in the flow direction R or through which the gas flow streams during operation of the turbomachine 10. The turbine 14 can thereby be connected via a shaft 16 to the compressor 12 and/or to the fan 11 in order to drive them. Depicted in the schematic illustration in FIG. 1 are the rotating stages 20, each of which has a guide vane arrangement 21 and a rotating blade arrangement 22.

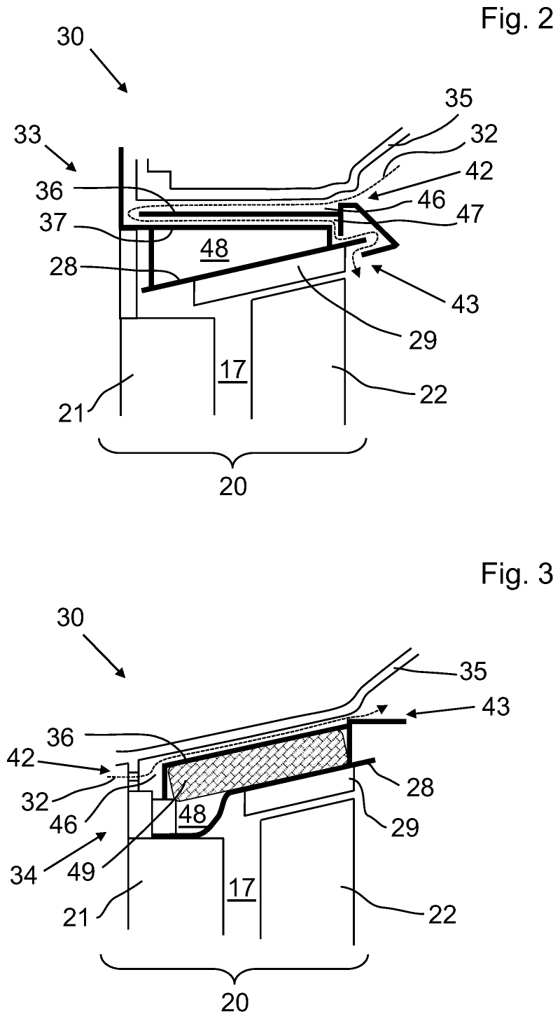

FIG. 2 shows a schematic sectional illustration of an exemplary embodiment of a section of a housing structure 30 according to the invention for a turbomachine 10, with a housing shell 35 that fulfills the requirements for absorbing all internal and external loads and fulfills a part of the containment requirement. The housing structure 30 surrounds the flow channel 17 of the turbomachine 10 in a ring-shaped manner, in which a plurality of rotating stages 20, each with a guide vane arrangement 21 and a rotating blade arrangement 22, are arranged. In one exemplary embodiment, two additional containment rings 36, 37 are arranged in the housing shell 35 and are fabricated, for example, from various materials. As depicted in FIG. 2, a respective additional containment ring 36, 37 extends with respect to the housing shell 35 essentially over the axial length of a rotating stage 20. Furthermore, it can be seen in the schematic illustration of the housing structure 30 in FIG. 2, by way of example, that at least one containment ring 36, 37 is arranged radially spaced apart from the housing shell 35 at least in sections.

In the embodiment illustrated schematically in FIG. 2, by way of example, the housing shell 35 and the two containment rings 36, 37 are each arranged radially spaced apart from each other. at least in sections. The radial spacing between the housing shell 35 and the containment ring 36 results in the formation a cavity 46 and, as a result of the radial spacing between the containment ring 36 and the containment ring 37, a cavity 47 is formed. The cavities 46 and 47 here are formed in such a way that a flow of cooling air can be carried in them. For this purpose, an air inlet opening 42 and an air outlet opening 43 are arranged at respectively suitable positions, so that an improved cooling function of the housing structure 30 is made possible. For the exemplary embodiment illustrated in FIG. 2, the cavities 46, 47 are formed so that cooling air 32 can flow through them from a cooling air source lying downstream.

In the exemplary embodiment illustrated in FIG. 2, the containment ring 37 is arranged spaced apart, at least in sections, from the seal support 28 radially surrounding the rotating stage 20, at which a sealing element 29, formed in a ring-shaped manner, is arranged. A cavity formed between the containment ring 37 and the seal support 28 is thereby sealed against an axial flow, in particular, a flow of air. Further shown schematically in the illustration in FIG. 2 is also an embodiment in which the containment ring 37 and the housing shell 35 form a mount 33 for a section of an adjoining guide vane of a guide vane arrangement 21. Furthermore, in the depicted housing structure 30, an axial back end of the containment ring 37 is arranged in a fastening region of the seal support 28 and the guide vane of a guide vane arrangement 21 is arranged at the housing shell 35.

FIG. 3 shows a schematic sectional illustration of an exemplary embodiment of a section of a housing structure 30 according to the invention for a turbomachine 10, with a housing shell 35 that fulfills the requirements for absorbing all internal and external loads and fulfills a part of the containment requirement. The housing structure 30 surrounds the flow channel 17 of the turbomachine 10 in a ring-shaped manner, in which a plurality of rotating stages 20, each with a guide vane arrangement 21 and a rotating blade arrangement 22, are arranged. In the exemplary embodiment, a containment ring 36 is arranged in the housing shell 35 and, for example, is fabricated from a different material than that of the housing shell 35. As depicted in FIG. 3, a respective containment ring 36 extends essentially over the axial length of a rotating stage 20.

In the embodiment depicted in FIG. 3, by way of example, the housing shell 35 and the containment ring 36 are arranged spaced radially apart from one another, at least in sections. The radial spacing between the housing shell 35 and the containment ring 36 results in the formation of a cavity 46. The cavity 46 is formed here in such a way that a flow of cooling air can be carried in it. For this purpose, an air inlet opening 42 and an air outlet opening 43 are arranged at respectively suitable positions, so that an improved cooling function of the housing structure 30 is made possible. In the exemplary embodiment illustrated in FIG. 3, the cavity 46 is formed in such way that cooling air 32 can flow through it from an upstream cooling air source.

In the embodiment illustrated in FIG. 3, by way of example, the containment ring 36 is arranged spaced apart, at least in sections, from the seal support 28 radially surrounding the rotating stage 20, at which a sealing element 29 is arranged in a ring-shaped manner. An insulating element 49 is hereby arranged in the cavity 48 that is formed between the containment ring 36 and the seal support 28. Further arranged in the depicted housing structure 30 is an axial back end of the containment ring 36 in a fastening region of the seal support 28 and the guide vane of a guide vane arrangement 21.

What is claimed is:

1. A housing structure for a turbomachine, comprising:
a housing shell and at least one containment ring arranged therein, wherein the housing structure surrounds a flow channel in a ring-shaped manner, wherein at least one rotating stage with a guide vane arrangement and a rotating blade arrangement is arranged,
wherein at least one containment ring extends substantially over the axial length of a rotating stage and is arranged spaced radially apart from the housing shell, at least in sections, wherein the radial spacing between the at least one containment ring and the housing shell defines at least one cavity.

2. The housing structure according to claim 1, wherein the housing structure has at least two containment rings, which extend over the same rotating stage.

3. The housing structure according to claim 2, wherein the at least two containment rings are arranged spaced radially apart from each other, at least in sections.

4. The housing structure according to claim 3, wherein the radial spacing between the at least one containment ring and at least one second containment ring defines at least one cavity.

5. The housing structure according to claim 4, wherein the at least one cavity is configured and arranged for carrying a flow of cooling air.

6. The housing structure according to claim 1, wherein the at least one cavity is configured and arranged so cooling air can flow through it from a cooling air source lying upstream.

7. The housing structure according to claim 1, wherein the at least one cavity is configured and arranged so cooling air can flow through it from a cooling source lying downstream and/or
in that at least one containment ring is arranged spaced apart, at least in sections, from a seal support radially surrounding the rotating stage.

8. The housing structure according to claim 7, wherein a cavity, disposed between the containment ring and the seal support, is sealed against an axial flow and/or an insulating element is arranged in it.

9. The housing structure according to claim 1,
wherein at least one containment ring and the housing shell form at least one mount for a section of at least one adjoining guide vane, and/or
wherein an axial front end and/or back end of at least one containment ring is arranged at a fastening region of the seal support and/or of the guide vane at the housing shell.

10. The housing structure according to claim 1, wherein the housing shell does not have a required containment capability and the required containment capability is afforded only together with the one or more containment rings.

11. The housing structure according to claim 1, wherein an axial front end and/or back end of at least one seal support is arranged in a fastening region of at least one containment ring and/or of the guide vane at the housing shell.

12. The housing structure according to claim 1, wherein the axial extension of at least one of the containment rings lies in a region that extends from at least the axial extension of a rotating blade arranged inside of the containment ring up to twice the axial extension of such a rotating blade.

13. The housing structure according to claim 1,
wherein the at least one containment ring is fabricated from a material that differs from the material of the housing shell, and/or
wherein at least one containment ring is fabricated from a material that differs from the material of at least one other containment ring.

14. The housing structure according to claim 1, wherein the housing structure is configured and arranged as the outer housing of a turbine.

15. A turbomachine comprising a housing structure of claim 1.
